(19) United States
(12) Patent Application Publication
(10) Pub. No.: US 2009/0266949 A1
(43) Pub. Date: Oct. 29, 2009

(54) Universal Dishwasher Anchoring Bracket

(76) Inventor: James Michael Peay, Brentwood, TN (US)

Correspondence Address: James Michael Peay, 1525 Puryear Place, Brentwood, TN, 37027, US

(21) Appl. No.: 12/108,811

(22) Filed: Apr. 24, 2008

(51) Int. Cl. A47B 96/06; F16M 11/00

(52) U.S. Cl. 248/205.1; 248/200

(57) ABSTRACT

The universal dishwasher anchoring bracket is made of one piece of pressed metal or thin material that has folds pressed into it for added strength. It is standard dishwasher width not inclusive of the tabs at either end. It is symmetrical making it impossible to install backward. There is a tab at either end with a pressed indention facilitating an easy bend. There are screw holes in these tabs for attachment to cabinets with flat head screws. There are two elongated anchor strap attachment areas consisting of numerous pierced screw holes to facilitate attachment to the anchor straps of virtually all dishwashers being marketed. There is a center area for flexible caulk/adhesive placement that has bends for strength and to conceal any excess caulk squeezed out in application.

### BACKGROUND OF THE INVENTION

1. Field of the Invention

The present invention relates to the anchoring of dishwashers. More specifically, the invention relates to the anchoring of dishwashers under natural stone, concrete or any solid surface countertop.

2. Description of the Related Art

Current anchoring devices being used to anchor dishwashers are installed by countertop installers and must be glued into place with epoxy while attached to the dishwasher for alignment purposes. This process is messy, cumbersome and time consuming.

Additionally, the dishwasher has to be at the site in order to line up the anchoring straps to the brackets. If the dishwasher is not at the site the installer must make a return trip in order to install the anchoring device.

A further inconvenience of this technique is that the plumber must unscrew the anchoring straps from the anchoring bracket and pull the dishwasher out to connect the lines during the plumbing trim out and then reattach the dishwasher anchoring straps to the anchoring bracket after plumbing trim out.

An alternative method presently being used involves anchoring the dishwasher to the sides of the cabinet without any additional support from the countertop. This requires the purchase of special dips and/or modification of the dishwasher anchoring straps in order to work.

This potentially can do damage to cabinets over time due to lack of support at the top of dishwasher from countertops.

Thus, a universal anchoring bracket that fastens to the cabinet with screws as well as to the solid surface countertop with flexible caulk/adhesive to absorb shock of opening/dosing and further stabilize the dishwasher, along with removing the need for the dishwasher to be present at site for lining up of anchoring brackets with the anchoring straps is desired.

### BRIEF SUMMARY OF THE INVENTION

The universal dishwasher anchoring bracket is standard dishwasher width not inclusive of the end tabs. It has bendable tabs on either end that allows it to be mounted from the top, when left unbent, or to the sides, when bent. It is thin enough to allow attachment of dishwasher anchoring straps with (2) #8×¼″ long screws and strong enough to hold the dishwasher securely.

The dishwasher anchor strap attachment area has pierced holes instead of drilled for added strength. The pierced holes are spaced in a configuration that will accommodate the attachment of virtually all dishwashers presently marketed.

There is a recess at the top for adhesive to be applied for attachment to solid surface counter tops. The area is longer to allow more attachment surface with folded edges for added strength and to conceal any excess adhesive that squeezes out during application.

The bracket is symmetrical and cannot be installed backward.

The multiple attachment locations make it unnecessary to have the dishwasher at the site for anchor location determination. It also eliminates the need for the dishwasher being anchored prior to plumbing trim out. Thus, removing the aggravation of the plumber having to unattach the dishwasher from the anchors, pull it out, attach the plumbing, then put it back and reattach it to the anchors.

These and other features of the present invention will become readily apparent upon further review of the following specification and drawings.

### BRIEF DESCRIPTION OF THE SEVERAL VIEWS OF THE DRAWING

FIG. 1 is a perspective view of a universal anchoring bracket according to the present invention.

FIG. 2 is a section view drawn along line 2-2 of FIG. 1.

FIG. 3 is a section view drawn along line 3-3 of FIG. 1.

FIG. 4 is an environmental perspective view of the universal anchoring bracket being used in the top of cabinet/under counter top installation method.

FIG. 5 is an environmental perspective view of the universal anchoring bracket being used in the side of cabinet/under counter top installation method.

### DETAILED DESCRIPTION OF THE INVENTION

Applicant has recognized that a need exists for a universal dishwasher anchoring bracket that can be installed before counter top installation or after with no need for the dishwasher or other appliance to be present for alignment purposes.

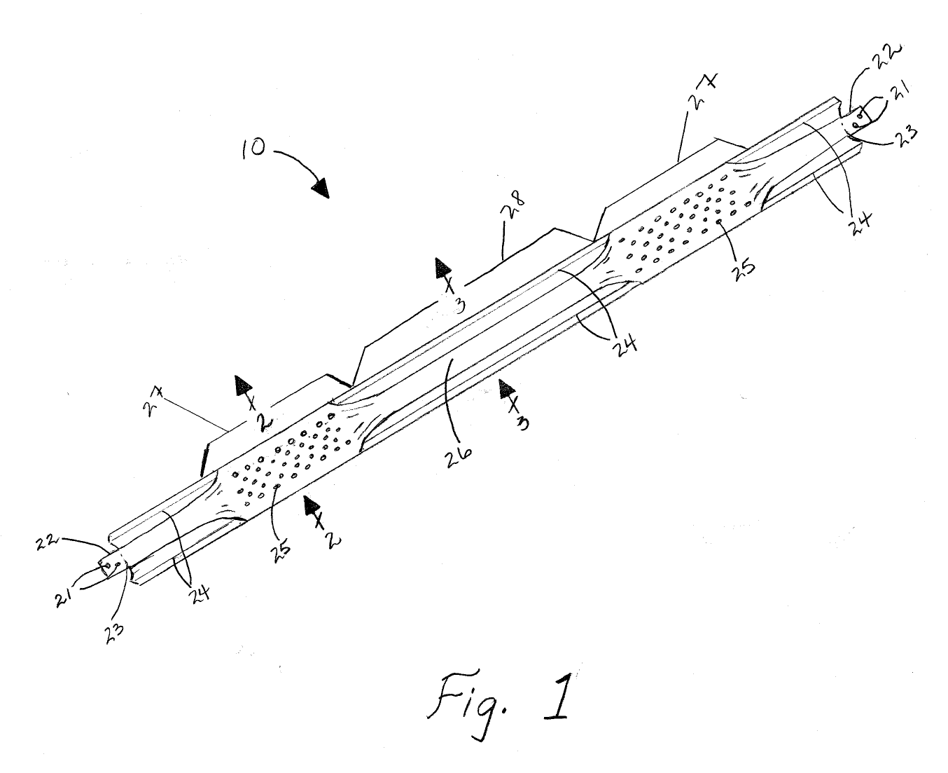

Features of embodiments of the present invention will now be described by first referring to FIG. 1 which is a perspective view of the dishwasher anchoring bracket. The anchoring bracket 10 includes a body which is symmetrical in all directions making it impossible to install backward. It is standard dishwasher width not inclusive of the end tabs. There are tabs 22 at both ends with screw holes 21 and a pressed indention 23 making the tabs easily bendable to ease installation in the under counter/inside opening installation method.

There are symmetrical sections 27 of pierced screw holes 25 for dishwasher anchoring strap attachment that will accommodate virtually any dishwasher on the market.

There are folds 24 pressed into the metal for strength making it possible to manufacture the bracket economically from sheet metal or other thin substances.

The center of the anchor 28 is designed for strength with folds 24 pressed into the metal and a recessed area 26 for flexible caulking/adhesive to be applied.

The folds 24 are also designed to conceal any excess caulk/adhesive that may squeeze out of the flexible caulking/adhesive area 26 during application. Keeping the installation neat in appearance.

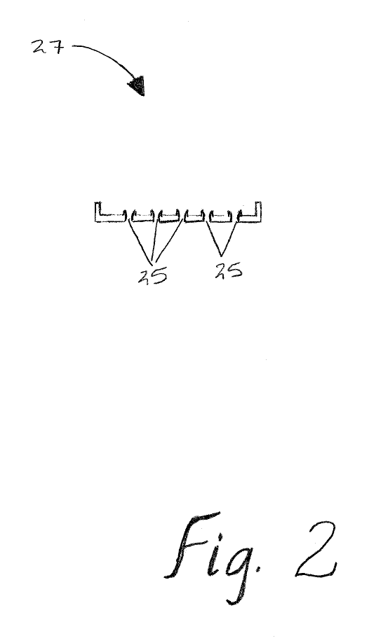

Reference is now made to FIG. 2 which depicts a section view drawn along line 2-2 of FIG. 1. This shows a cross section of one of the symmetrical sections 27 of pierced screw holes 25. The holes 25 are pierced to leave as much metal present for strengthening purposes. The holes 25 are also spaced and aligned in a manner to allow an extensive attachment area to accommodate virtually any dishwasher on the market.

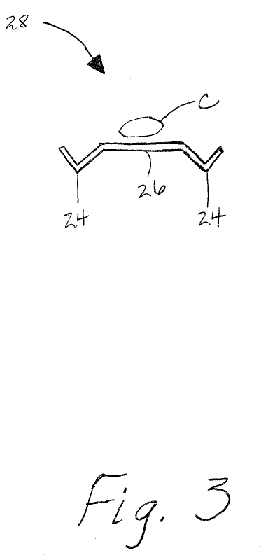

Reference is now made to FIG. 3 which depicts a section view drawn along line 3-3 of FIG. 1. This shows a cross section of the center area 28 of the anchor which has a recessed flexible caulking/adhesive area 26.

A strip of flexible caulking C should be applied to the center area 28 in the caulk area 26 at the time the solid surface counter top is installed. If after counter top installation caulk C should be applied in the flexible caulk/adhesive area 26 when the universal anchoring bracket is being attached to cabinet sides with screws.

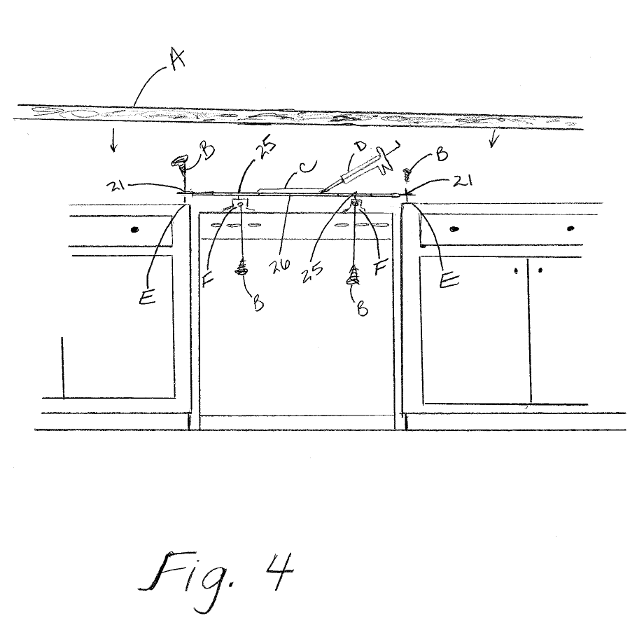

Reference is now made to FIG. 4. This depicts the anchor being used in the top mount position between the solid surface countertop A and the top of the cabinets E. The universal dishwasher anchoring bracket 10 would be mounted with screws B into the top of the cabinet E aligned with the front edge of the cabinets. The screws B are flat head screws to provide a virtually flush installation.

A strip of flexible caulk/adhesive C should be applied to the center area 28 at the flexible caulk/adhesive area 26 at the time the solid surface counter top is installed.

At the time of dishwasher installation there would only be a need to attach the dishwasher anchoring tabs F to the universal anchoring bracket 10 at attachment area 27 via one of the various screw holes 25. There is no need for alignment due to the numerous screw holes 25 located in the attachment area 27.

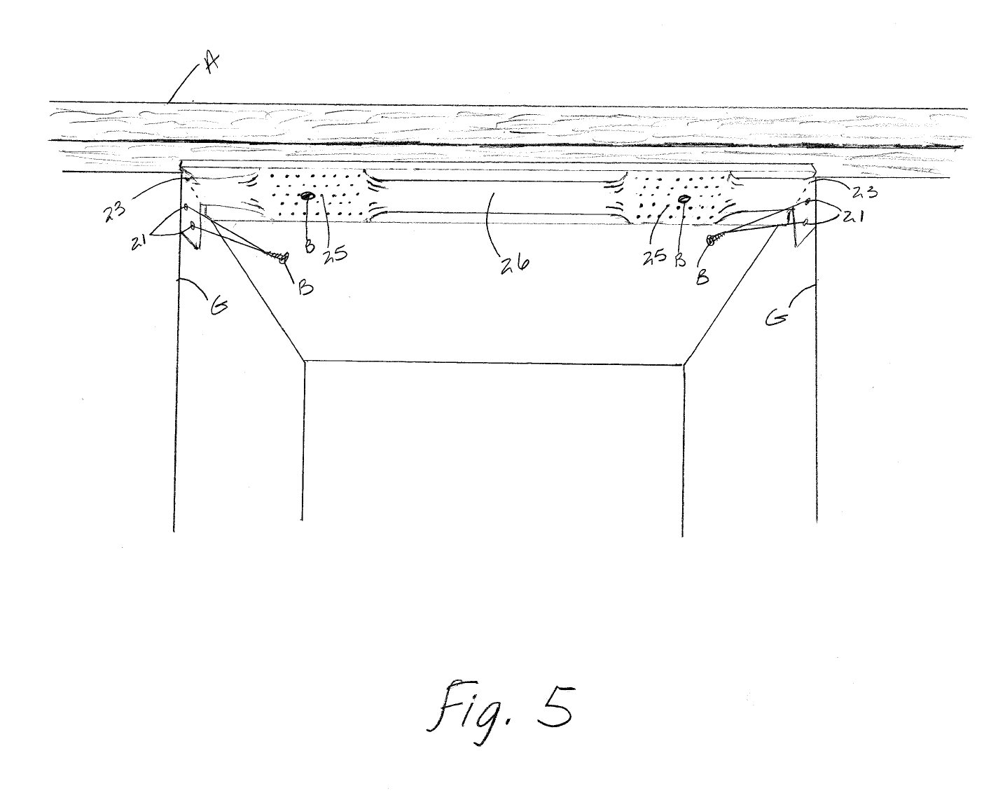

Reference is now made to FIG. 5. This depicts the anchor being used in the side mount position. This position is used if the counter top is already in place and the top of the cabinet is inaccessible. The end tabs are bent along the indention 23 to an angle of approximately 90 degrees. A strip of flexible caulking is applied to the center area 28 in the flexible caulk area/adhesive area 26 and pressed up against the counter top, the end tabs are then attached to the side of the cabinet G via the screw holes 25 with flat head screws B.

The result is an economically manufactured and easily installed universal dishwasher anchoring bracket 10. Further, the bracket eliminates the need for the dishwasher to be on site during installation due to the lack of need for alignment.

I claim:

1. A universal dishwasher anchoring bracket, comprising:
an elongated, symmetrical pressed metal bracket that is standard dishwasher width not inclusive of the end tabs made economically of one piece of pressed metal or other thin material designed in a manner to be compatible with virtually all dishwashers on the market

2. The bracket of claim 1 having bendable tabs with screw holes on either end to allow for top or side attachment to cabinets, making it usable at either time of cabinet installation or in the event of dishwasher replacement at a later time;

3. The bracket of claim 1 having two identical anchor attachment areas with multiple pierced screw holes making it compatible with most every dishwasher on the market;

4. The bracket of claim 1 having an elongated flexible caulk/adhesive application area to allow for more surface attachment to the counter top material, having folded edges for strength and for concealment of any excess caulk/adhesive that squeezes out during application, for a neater appearance.

5. The bracket of claim 1 being designed in such a manner as to not require alignment to dishwasher for installation purposes, thus eliminating the need for the dishwasher to be on site prior to installation.
